(19) United States
(12) Patent Application Publication
(10) Pub. No.: US 2009/0279299 A1
(43) Pub. Date: Nov. 12, 2009

(54) Illuminative light device for vehicle

(76) Inventor: Fang Lin Yang, Taichung Hsien (TW)

Correspondence Address: CHARLES E. BAXLEY, ESQUIRE, 90 JOHN STREET, SUITE 309, NEW YORK, NY, 10038, US

(21) Appl. No.: 12/152,060

(22) Filed: May 12, 2008

(51) Int. Cl. F21S 4/00; F21V 21/00

(52) U.S. Cl. 362/249.01

(57) ABSTRACT

An illuminative light device includes an electric circuit board disposed in a light housing, and a number of light members attached to the light housing and electrically coupled to the circuit board for being operated by the circuit board, and the light housing includes a channel formed between two spring legs for resiliently engaging with a supporting object and for easily and readily and quickly attached or mounted onto the supporting object without additional fasteners or latches and for allowing the light housing to be easily and readily and quickly attached or mounted onto the supporting object or the motor vehicles by the users themselves.

### BACKGROUND OF THE INVENTION

1. Field of the Invention

The present invention relates to an illuminative light device, and more particularly to an illuminative light device including an attachment or mounting structure for easily and readily and quickly attaching or mounting onto various supporting objects, such as various portions of the motor vehicles for illuminating purposes or for signalling purposes.

2. Description of the Prior Art

Typical lamp systems or illuminative light devices comprise a signal light housing for attaching or mounting onto the motor vehicles, and one or more signal lights disposed in the signal light hosing for illuminating purposes or for signalling purposes.

For example, U.S. Pat. No. 2,751,522 to Spangenberg discloses one of the typical signal light systems for motor vehicles which comprises a signal light hosing for attaching or mounting onto the motor vehicles and for electrically coupling to a mercury switch.

However, the signal light hosing may not be easily and readily and quickly attached or mounted onto the motor vehicles without latches or fasteners and may not be attached or mounted onto the motor vehicles by the users themselves.

U.S. Pat. No. 5,193,895 to Naruke et al. discloses another typical warning light system for motor vehicles comprising a narrow, ribbon-like light body for attaching or mounting onto the motor vehicles with a fixing member made of a double-side adhesive tape, flexible magnetic sheet, or the like.

However, the typical warning light system may not be solidly attached or mounted onto the motor vehicles and may be easily disengaged from the motor vehicles after use.

U.S. Pat. No. 5,490,049 to Montalan et al. discloses a further typical light emitting diode (LED) signalling light system for motor vehicles comprising a signalling light hosifig for attaching or mounting onto the rear end of the motor vehicles.

However, similarly, the typical signalling light system may not be easily attached or mounted onto the motor vehicles by the users themselves.

U.S. Pat. No. 6,425,679 to Yu discloses a still further typical auxiliary safety or turning light device for motor vehicles comprising a plate for attaching or mounting onto various portions of the motor vehicles with a fixing member made of an adhesive layer, or an adhesive tape, or the like.

However, similarly, the typical auxiliary safety or turning light device may not be solidly attached or mounted onto the motor vehicles and may be easily disengaged from the motor vehicles after use.

U.S. Pat. No. 6,648,492 to Shih discloses a still further typical connectable illuminative assembly comprising a number of light devices each having a circuit board disposed in a sucker member for attaching or mounting onto various portions of the motor vehicles with the sucker members.

However, the sucker members may quickly become loose and may be easily disengaged from the motor vehicles after use.

The present invention has arisen to mitigate and/or obviate the afore-described disadvantages of the conventional illuminative light devices for the motor vehicles.

### SUMMARY OF THE INVENTION

The primary objective of the present invention is to provide an illuminative light device including an attachment or mounting structure for easily and readily and quickly attached or mounted onto various supporting objects, such as various planar or edge portions of the motor vehicles for illuminating purposes or for signalling purposes.

In accordance with one aspect of the invention, there is provided an illuminative light device comprising a light housing, an electric circuit board disposed in the light housing, and a number of light members attached to the light housing and electrically coupled to the circuit board for being operated by the circuit board, and the light housing includes a channel formed therein and formed between two spring legs for engaging with a supporting object.

The channel is preferably formed in a lower portion of the light housing and facing away from the circuit board and the light members, or formed in one side portion of the light housing and opened or facing sidewise or laterally.

The light housing includes at least one projection extended into the channel of the light housing for engaging with the supporting object. The projection may be extended from one of the spring legs of the light housing.

The light housing includes one or more fixing members disposed therein for engaging with the supporting object, and the fixing members may be attached to the inner portion of the light housing, or attached to one of the spring legs of the light housing for further solidly engaging with the supporting object.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an illuminative light device in accordance with the present invention;

FIG. 2 is a cross sectional view of the illuminative light device taken along lines 2-2 of FIG. 1;

FIGS. 3, 4, 5 are cross sectional views similar to FIG. 2, illustrating the other arrangements of the illuminative light device; and

FIGS. 6, 7, 8, 9 are cross sectional views similar to FIGS. 2-5, illustrating the further arrangements of the illuminative light device.

### DETAILED DESCRIPTION OF THE PREFERRED EMBODIMENT

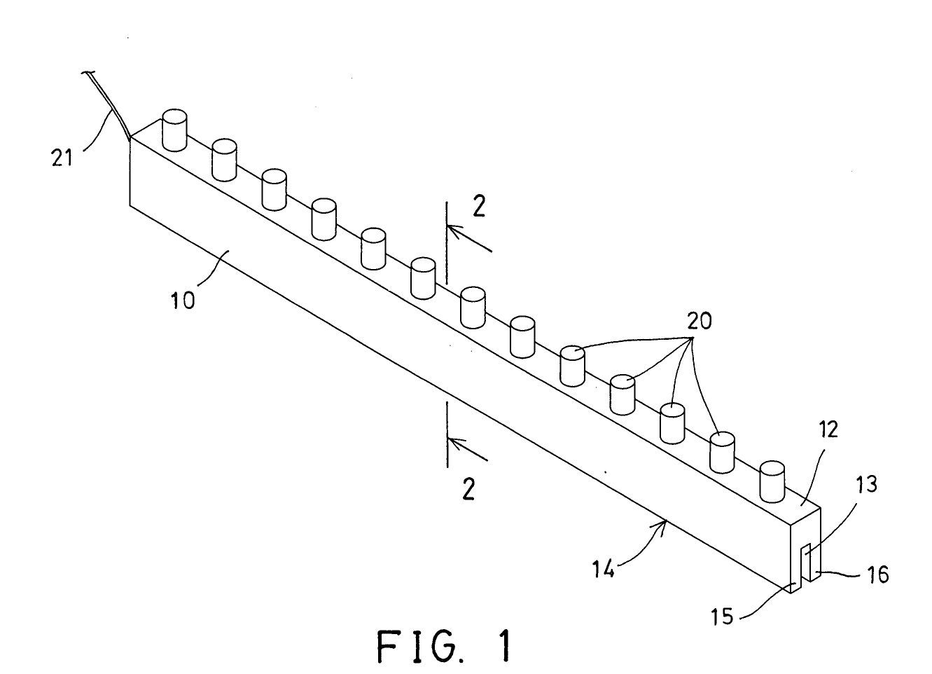

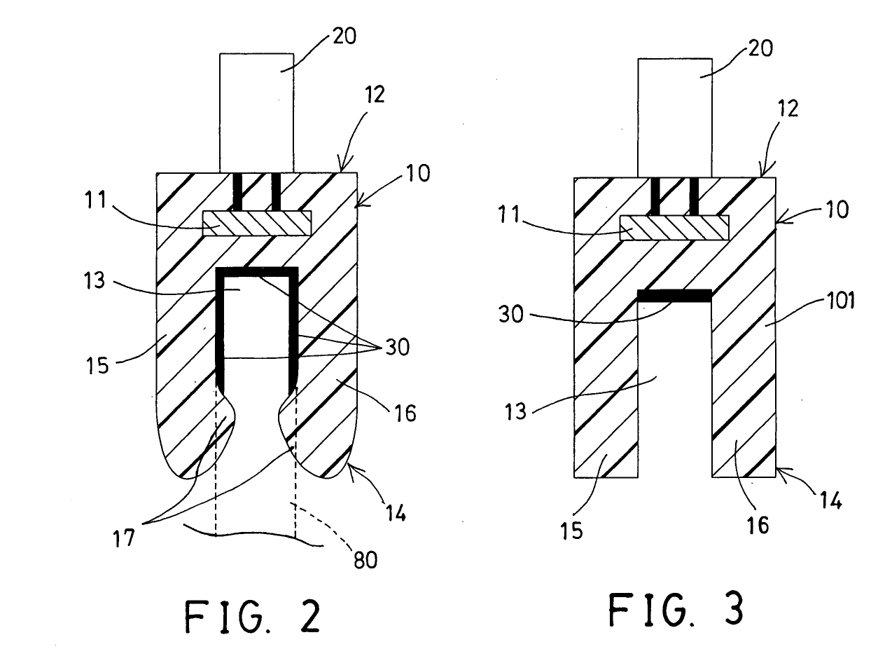

Referring to the drawings, and initially to FIGS. 1 and 2, an illuminative light device in accordance with the present invention comprises an elongated light housing 10 including an electric circuit board 11 disposed or engaged into the elongated light housing 10 and preferably disposed or arranged along the longitudinal direction of the elongated light housing 10, and a number of lamps, light bulbs, light devices, such as the light emitting diode (LED) or other light members 20 attached or mounted onto the side portion or the upper portion 12 of the light housing 10 and electrically coupled to the circuit board 11 for being selectively operated or energized by the circuit board 11.

The circuit board 11 may be electrically coupled to the electric power source of the motor vehicles, such as electrically coupled to the turning light devices, the brake light devices, or the other signalling light devices of the motor vehicles with an electric wire or cable 21 for being operated or actuated by the turning light devices, the brake light devices, or the other signalling light devices of the motor vehicles. The light housing 10 further includes a longitudinal channel 13 formed in the light housing 10, such as formed in the lower or bottom portion 14 of the light housing 10, and formed or defined between two spring legs 15, 16, and opened or facing opposite to or away from the circuit board 11 and the light members 20.

In operation, the longitudinal channel 13 of the light housing 10 may be provided for receiving or engaging with various supporting objects 80, such as various planar or edge portions of the motor vehicles, such as the window shields, the rain shields, the door panels, the trunk covers, or the like, and thus for easily and readily and quickly attaching or mounting onto various portions 80 of the motor vehicles without additional latches or fasteners and for allowing the light housing 10 to be easily and readily and quickly attached or mounted onto the motor vehicles by the users themselves. It is to be noted that the light housing 10 may be made of rubber, plastic, or other synthetic materials which may include a suitable or selected resilience or spring-biasing characteristic for allowing the spring legs 15, 16 of the light housing 10 to resiliently grasp or engage with the motor vehicles.

As shown in FIG. 2, the light housing 10 may further include one or more (such as two) projections 17 extended from the spring legs 15, 16 of the light housing 10 and extended inwardly or into the channel 13 of the light housing 10 for further engaging with the various portions 80 of the motor vehicles and for further resiliently or solidly grasping or engaging with the motor vehicles, and the light housing 10 may further include one or more fixing members 30, 31, such as adhesive tapes or adhesive layers 30, 31 attached or disposed or engaged into the inner portion of the light housing 10, and/or attached to the spring legs 15, 16 of the light housing 10 for engaging with the various portions 80 of the motor vehicles and for further solidly securing the light housing 10 to the motor vehicles.

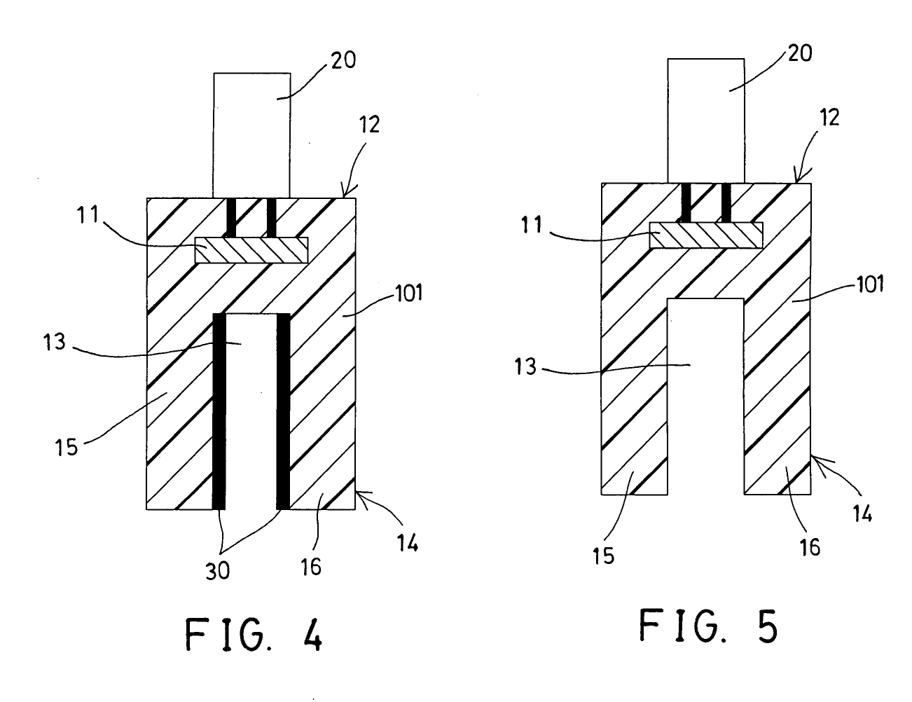

Alternatively, as shown in FIG. 3, the fixing member 30 may only be attached or disposed or engaged into the inner portion of the light housing 101, or the fixing member 31 may be attached to the spring legs 15, 16 of the light housing 101 as shown in FIG. 4, or the light housing 101 may include no fixing members 30, 31 disposed or attached therein as shown in FIG. 5.

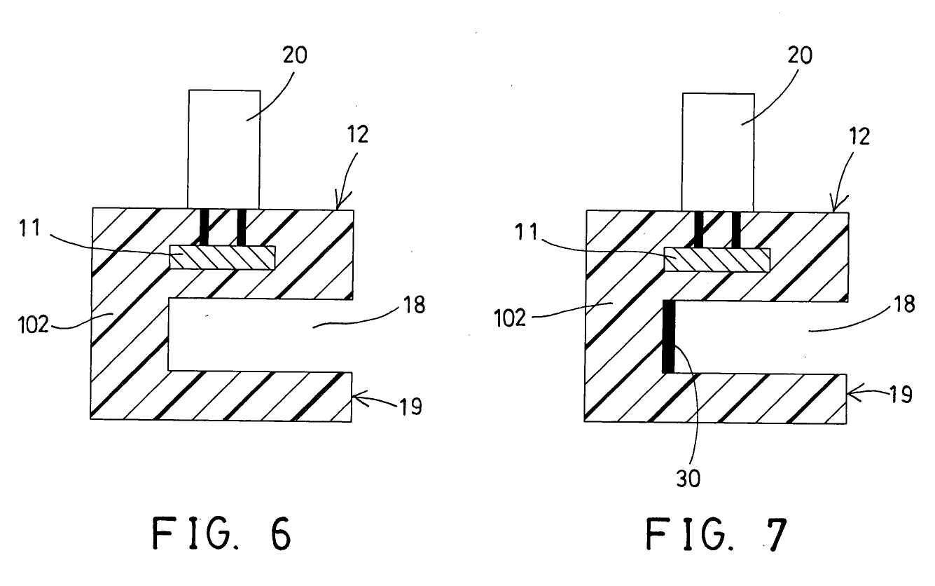

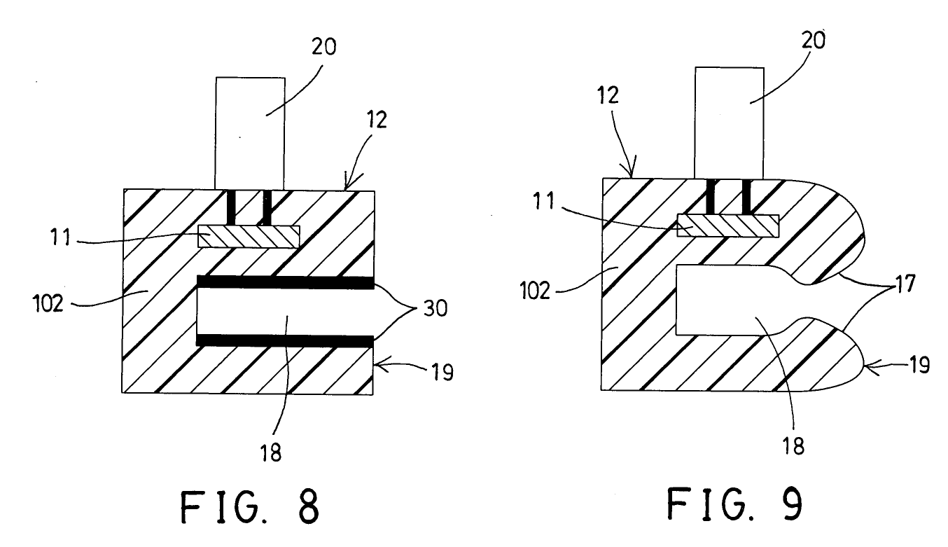

Further alternatively, as shown in FIGS. 6-9, the light housing 102 may include channel 18 formed in the side portion 19 of the light housing 10 and opened or facing sidewise or laterally for receiving or engaging with the various portions of the motor vehicles, and may include one or more fixing members 30 attached or disposed or engaged into the inner portion of the light housing 102 (FIG. 7), or attached to the spring legs 15, 16 of the light housing 102 (FIG. 8), or may include no fixing members 30, 31 disposed or attached therein (FIG. 6), or may include one or more projections 17 extended from the spring legs 15, 16 and extended into the channel 13 of the light housing 10 for further resiliently or solidly grasping or engaging with the motor vehicles.

Accordingly, the illuminative light device in accordance with the present invention includes an attachment or mounting structure for easily and readily and quickly attached or mounted onto various supporting objects, such as various portions of the motor vehicles for illuminating purposes or for signalling purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. An illuminative light device comprising:
a light housing,
an electric circuit board disposed in said light housing, and a plurality of light members attached to said light housing and electrically coupled to said circuit board for being operated by said circuit board, and
said light housing including a channel formed in a lower portion of said light housing and facing away from said circuit board and said light members and formed between two spring legs for engaging with a supporting object, and said light housing including at least one projection extended from one of said spring legs of said light housing and extended into said channel of said light housing for engaging with the supporting object, and said light housing including a first fixing member disposed therein, and including a second fixing member attached to one of said spring legs of said light housing for engaging with the supporting object.

2-6. (canceled)
